(19) United States
(12) Patent Application Publication
(10) Pub. No.: US 2022/0013793 A1
(43) Pub. Date: Jan. 13, 2022

(54) FUEL CELL METAL SEPARATOR AND POWER GENERATION CELL

(71) Applicant: HONDA MOTOR CO., LTD., Tokyo (JP)

(72) Inventors: Suguru OHMORI, Wako-Shi (JP); Takuro OKUBO, Wako-Shi (JP)

(21) Appl. No.: 17/372,799

(22) Filed: Jul. 12, 2021

(30) Foreign Application Priority Data
Jul. 13, 2020 (JP) 2020-120183

(51) Int. Cl. H01M 8/0206; H01M 8/0267; H01M 8/0276; H01M 8/0265; H01M 8/248

(52) U.S. Cl. CPC H01M 8/0206; H01M 8/0267; H01M 8/248; H01M 8/0265; H01M 8/0276

(57) ABSTRACT

In a flange in the form of a flat plate inside a bead seal (e.g., fluid passage bead) around a fluid passage (e.g., an oxygen-containing gas supply passage) of a fuel cell metal separator (e.g., a first metal separator), a tunnel is provided in a straight segment adjacent to a curved segment of an inner marginal portion of the flange. The tunnel is formed by expansion in a separator thickness direction.

### CROSS-REFERENCE TO RELATED APPLICATION

This application is based upon and claims the benefit of priority from Japanese Patent Application No. 2020-120183 filed on Jul. 13, 2020, the contents of which are incorporated herein by reference.

### BACKGROUND OF THE INVENTION

### Field of the Invention

The present invention relates to a fuel cell metal separator having a bead seal around a fluid passage, and also relates to a power generation cell.

### Description of the Related Art

A solid polymer electrolyte fuel cell includes a membrane electrode assembly (MEA). The MEA includes an electrolyte membrane, an anode formed on one surface of the electrolyte membrane, and a cathode formed on the other surface of the electrolyte membrane. The electrolyte membrane is a polymer ion exchange membrane. The membrane electrode assembly is sandwiched between separators (bipolar plates) to form a power generation cell (unit fuel cell). Further, a fuel cell stack comprises a stack body formed by stacking a predetermined number of power generation cells together. For example, the fuel cell stack is incorporated into a fuel cell vehicle (fuel cell automobile).

In the fuel cell stack, as the separators, metal separators may be used. In this case, a seal member is provided for preventing leakage of an oxygen-containing gas (e.g., an air), a fuel gas (e.g., a hydrogen gas), and a coolant. Some metal separators adopt bead seals as seal members where seal structure of metal is formed by shaping the metal separators to have protrusions. For example, the fuel cell stack of this type is disclosed in JP 2019-046755 A, the specification of US 2018/0131016 A1, and U.S. Pat. No. 10,355,289 B2.

A part of the bead seal is formed around fluid passages extending through the metal separator in a stacking direction. Further, the metal separator is provided with a bridge section as an area where one or a plurality of connection channels connecting the inner side and the outer side of the bead seal are formed, for allowing reactant gases to flow between the power generation area and the fluid passages. Each of the connection channels of the bridge section protrudes from the side wall of the bead seal toward the inner side and outer side of the bead seal, and functions as a tunnel formed by expansion in the separator thickness direction.

The metal separator on which the bead seal is formed is incorporated as part of the power generation cell, and a plurality of the power generation cells are stacked together in the stacking direction to apply a compression load in the stacking direction to form a fuel cell stack. Therefore, a compression load is applied to the bead seal of the metal separator.

### SUMMARY OF THE INVENTION

In the metal separator, a flange is formed inside the bead seal around the fluid passage. The flange protrudes toward the fluid passage along the same plane as a base plate forming a main surface of the metal separator. However, when the bead seal is compressed, stress is exerted on the flange in its protruding direction, so as to cause a problem that the flange is deformed by bending in the thickness direction of the flange, near corners (curved segments) where stresses tend to be concentrated. If bending of the flange occurs, there is a concern that the compression load applied to the bead seal around the fluid passage becomes non-uniform, and the seal performance is degraded.

In view of the above, an object of the present invention is to provide a fuel cell metal separator and a power generation cell in which, when the fuel cell metal separator is compressed, it is possible to suppress deformation of a flange around a fluid passage.

According to an aspect of the present invention, a fuel cell meal separator is provided. The fuel cell metal separator includes a reactant gas flow field configured to allow an oxygen-containing gas or a fuel gas to flow in a direction along an electrode surface, a fluid passage connected to the reactant gas flow field and penetrating through the fuel cell metal separator in a separator thickness direction, a metal bead seal provided around the fluid passage, and protruding in the separator thickness direction, a flange provided between a root of the bead seal and the fluid passage, and a bridge section protruding from a side wall of the bead seal and protruding from a separator main surface in the separator thickness direction. A connection channel configured to connect the fluid passage and the reactant gas flow field is formed in the bridge section. The fuel cell metal separator is stacked on a membrane electrode assembly in a stacking direction, and a compression load is applied to the fuel cell metal separator in the stacking direction. An inner marginal portion of the flange is formed to have an annular shape by connecting a plurality of straight segments and curved segments, each of which connects the straight segments, and a tunnel connected to the bead seal, and formed by expansion of the flange in the separator thickness direction is provided in the straight segment adjacent to the curved segment in a section other than the bridge section.

According to another aspect of the present invention, a power generation cell is provided. The power generation cell includes the fuel cell metal separator according to the above aspect and a membrane electrode assembly stacked on the fuel cell metal separator.

In the fuel cell metal separator and the power generation cell according to the above aspects, when the fuel cell metal separator is compressed, it is possible to suppress deformation of the flange around the fluid passage.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view showing a fuel cell stack;

FIG. 2 is an exploded perspective view showing the fuel cell stack;

FIG. 3 is a cross sectional view taken along a line III-III in FIG. 2;

FIG. 4 is an exploded perspective view showing a power generation cell of the fuel cell stack;

FIG. 5 is a front view showing a joint separator viewed from a side where a first metal separator is present;

FIG. 6A is a plane view showing a fluid passage bead around an oxygen-containing gas supply passage in the first metal separator;

FIG. 6B is a cross sectional view taken along a line VIB-VIB in FIG. 6A;

FIG. 7A is a cross sectional view taken along a line VIIA-VIIA in FIG. 6A;

FIG. 7B is an view showing the tunnel in FIG. 7A, viewed from an oxygen-containing gas supply passage;

FIG. 8 is a front view showing a joint separator viewed from a side where a second metal separator is present;

FIG. 9 is a view showing bending of a flange according to a comparative example;

FIG. 10A is a view showing stress applied to a tunnel of a flange according to the embodiment;

FIG. 10B is a cross sectional view showing stress relief mechanism by the tunnel; and

FIG. 11 is a view showing main parts of stress relief structure of a flange according to a modified embodiment.

### DESCRIPTION OF THE PREFERRED EMBODIMENTS

Hereinafter, preferred embodiments of a fuel cell metal separator and a power generation cell will be described in detail with reference to the accompanying drawings.

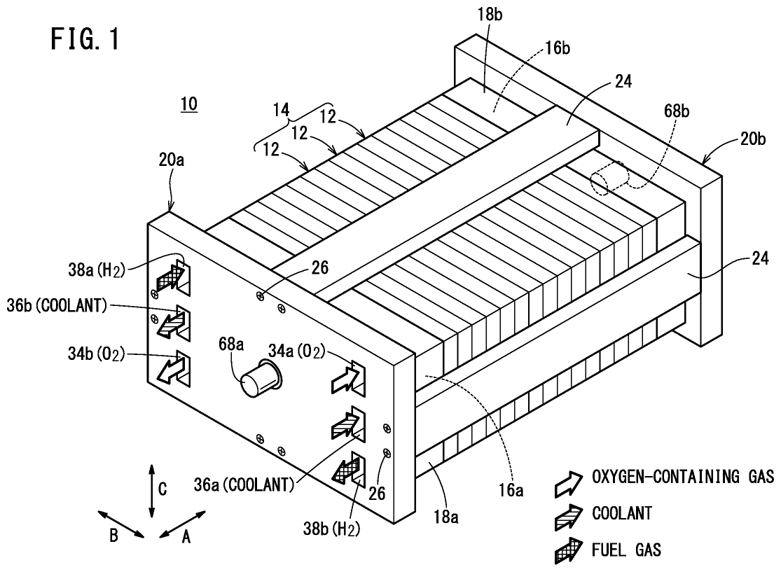

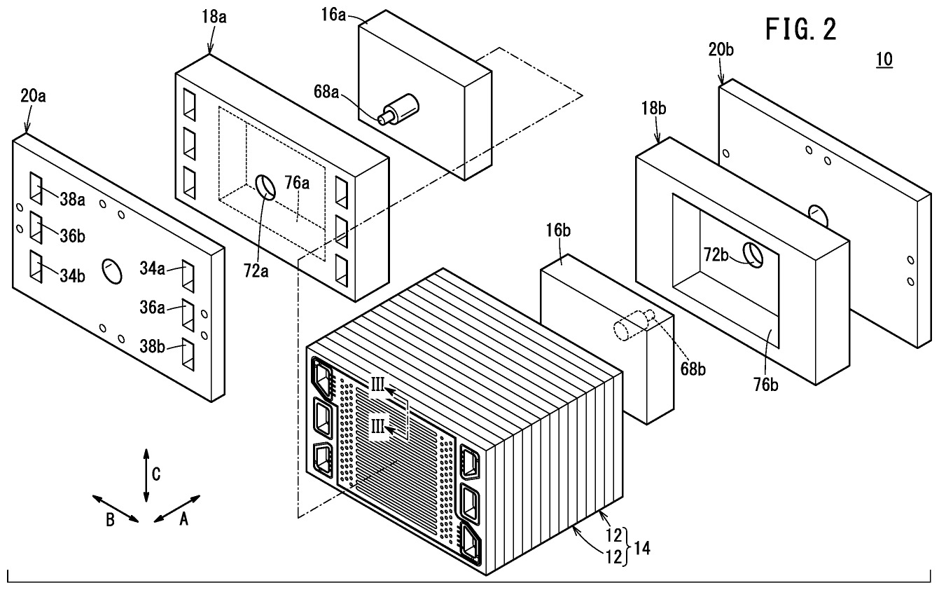

As shown in FIGS. 1 and 2, a fuel cell stack 10 includes a stack body 14 formed by stacking a plurality of power generation cells 12 (fuel cells) in a horizontal direction (direction indicated by an arrow A) or a gravity direction (direction indicated by an arrow C) For example, the fuel cell stack 10 is mounted in a fuel cell vehicle such as a fuel cell automobile (not shown).

At one end of the stack body 14 in the stacking direction (direction indicated by the arrow A), a terminal plate 16a is provided. An insulator 18a is provided outside the terminal plate 16a, and an end plate 20a is provided outside the insulator 18a (see FIG. 2). At the other end of the stack body 14 in the stacking direction, a terminal plate 16b is provided. An insulator 18b is provided outside the terminal plate 16b, and an end plate 20b is provided outside the terminal plate 16b.

As shown in FIG. 1, the end plates 20a, 20b have a laterally elongated (or longitudinally elongated) rectangular shape, and coupling bars 24 are disposed between the sides of the end plates 20a, 20b. Both ends of each of the coupling bars 24 are fixed to the inner surfaces of the end plates 20a, 20b, and a tightening load is applied to the power generation cells 12 stacked in the stacking direction (direction indicated by the arrow A) through bolts 26. It should be noted that the fuel cell stack 10 may be provided with a casing including the end plates 20a, 20b, and the stack body 14 may be placed in the casing.

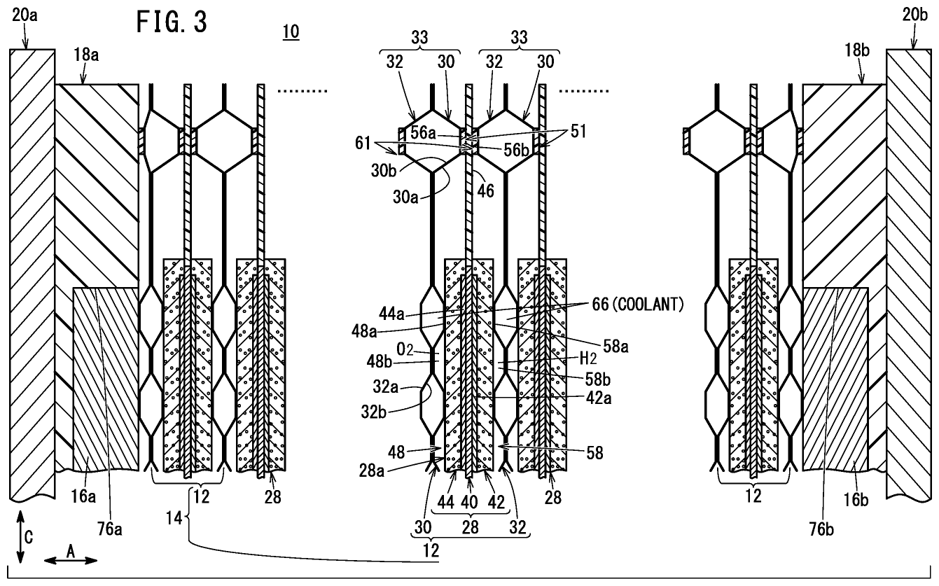

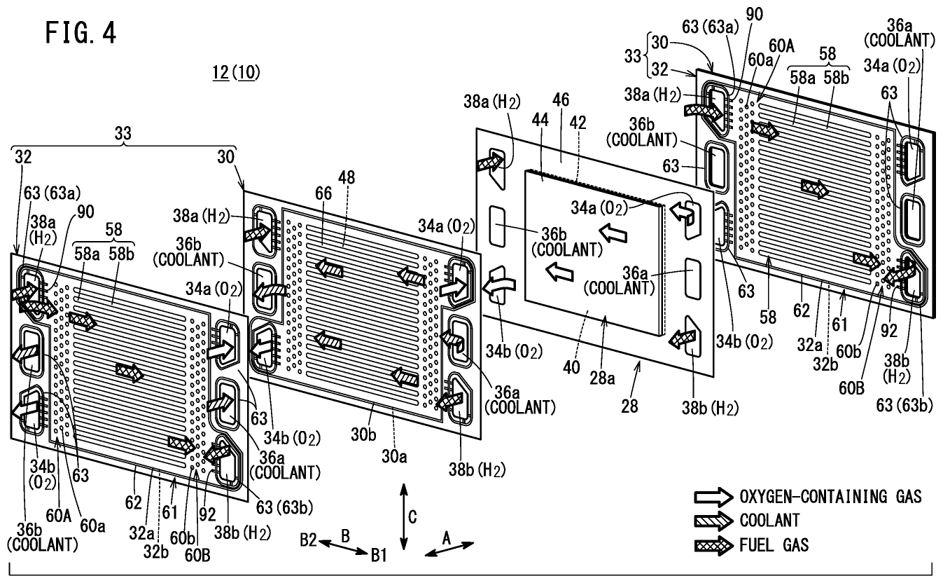

As shown in FIGS. 3 and 4, the resin film equipped MEA 28 is sandwiched between a first metal separator 30 and a second metal separator 32 to form the power generation cell 12. For example, each of the first metal separator 30 and the second metal separator 32 is a steel plate, a stainless steel plate, an aluminum plate, a plated steel plate, or a metal plate having an anti-corrosive surface by surface treatment, and formed by press forming to have a corrugated shape in cross section and a wavy shape on the surface. An outer peripheral portion of the first metal separator 30 and an outer peripheral portion of the second metal separator 32 are joined together by jointing means such as welding, brazing, crimping, etc. integrally to form a joint separator 33.

As shown in FIG. 4, at one end of the power generation cell 12 in the long side direction indicated by the arrow B (horizontal direction in FIG. 4), an oxygen-containing gas supply passage 34a, a coolant supply passage 36a, and a fuel gas discharge passage 38b are provided. The oxygen-containing gas supply passage 34a, the coolant supply passage 36a, and the fuel gas discharge passage 38b extend through the power generation cell 12 in the stacking direction (direction indicated by the arrow A). The oxygen-containing gas supply passage 34a, the coolant supply passage 36a, and the fuel gas discharge passage 38b are arranged in the direction indicated by the arrow C. An oxygen-containing gas is supplied through the oxygen-containing gas supply passage 34a. A coolant is supplied through the coolant supply passage 36a. A fuel gas such as a hydrogen-containing gas is discharged through the fuel gas discharge passage 38b.

At the other end of the power generation cell 12 in the direction indicated by the arrow B, a fuel gas supply passage 38a, a coolant discharge passage 36b, and an oxygen-containing gas discharge passage 34b are arranged in the direction indicated by the arrow C. The fuel gas supply passage 38a, the coolant discharge passage 36b, and the oxygen-containing gas discharge passage 34b extend through the power generation cell 12 in the direction indicated by the arrow A. The fuel gas is supplied through the fuel gas supply passage 38a. The coolant is discharged through the coolant discharge passage 36b. The oxygen-containing gas is discharged through the oxygen-containing gas discharge passage 34b. The layout of the oxygen-containing gas supply passage 34a, the oxygen-containing gas discharge passage 34b, the coolant supply passage 36a, the coolant discharge passage 36b, the fuel gas supply passage 38a, and the fuel gas discharge passage 38b is not limited to the embodiment of the present invention, and may be determined as necessary depending on the required specification

As shown in FIG. 3, the resin film equipped MEA 28 having a resin film 46 on its outer peripheral portion includes a membrane electrode assembly 28a. The membrane electrode assembly 28a includes an electrolyte membrane 40, and an anode 42 and a cathode 44 sandwiching the electrolyte membrane 40.

For example, the electrolyte membrane 40 is a solid polymer electrolyte membrane (cation ion exchange membrane). For example, the solid polymer electrolyte membrane is a thin membrane of perfluorosulfonic acid containing water. A fluorine based electrolyte may be used as the electrolyte membrane 40. Alternatively, an HC (hydrocarbon) based electrolyte may be used as the electrolyte membrane 40. The surface size of the electrolyte membrane 40 is smaller than the surface sizes of the anode 42 and the cathode 44.

A frame shaped resin film 46 is sandwiched between an outer peripheral portion of the anode 42 and an outer peripheral portion of the cathode 44. An inner peripheral end surface of the resin film 46 is positioned close to, overlapped with, or contacts an outer peripheral end surface of the electrolyte membrane 40. As shown in FIG. 4, at an end of the resin film 46 in the direction indicated by the arrow B, the oxygen-containing gas supply passage 34a, the coolant supply passage 36a, and the fuel gas discharge passage 38b are provided. At the other end of the resin film 46 in the direction indicate by the arrow B, the fuel gas supply passage 38a, the coolant discharge passage 36b, and the oxygen-containing gas discharge passage 34b are provided.

Examples of materials of the resin film 46 include PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether) resin, PET (polyethylene terephthalate), PBT (polybutylene terephthalate), or modified polyolefin. It should be noted that, instead of using the resin film 46, the electrolyte membrane 40 may be configured to protrude outward. Further, frame shaped films which protrude outward may be provided on both sides of the electrolyte membrane 40.

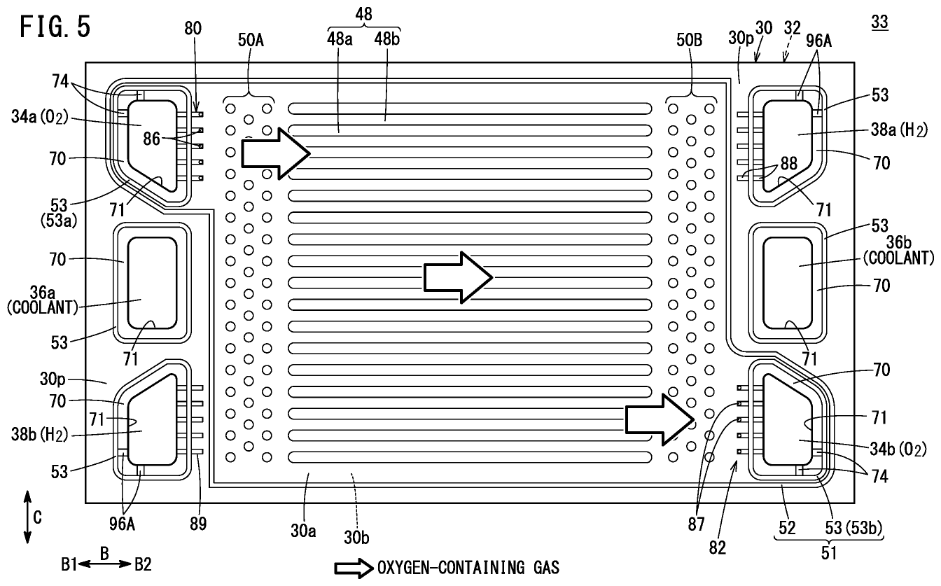

As shown in FIG. 4, the first metal separator 30 has an oxygen-containing gas flow field 48 on its surface 30a facing the resin film equipped MEA 28 (hereinafter referred to as the “surface 30a”). For example, the oxygen-containing gas flow field 48 extends in the direction indicated by the arrow B. As shown in FIG. 5, the oxygen-containing gas flow field 48 is in fluid communication with the oxygen-containing gas supply passage 34a and the oxygen-containing gas discharge passage 34b. The oxygen-containing gas flow field 48 includes a plurality of straight flow grooves 48b formed between a plurality of ridges 48a extending in the direction indicated by the arrow B. Instead of the plurality of straight flow grooves 48b, a plurality of wavy flow grooves may be provided.

A first seal line 51 (metal bead seal) is formed on a surface 30a of the first metal separator 30 by press forming. The first seal line 51 is expanded toward the resin film equipped MEA 28. The first seal line 51 includes an outer bead 52 and a plurality of fluid passage beads 53 (bead seal). As shown in FIG. 3, a resin member 56a is fixed to a protruding end surface of the first seal line 51 by printing or coating. For example, polyester fiber is used as the resin member 56a. The resin member 56a is not essential. The resin member 56a may be dispensed with.

As shown in FIG. 5, the outer bead 52 protrudes from the surface 30a of the first metal separator 30 toward the resin film equipped MEA 28 (FIG. 4), and surrounds the oxygen-containing gas flow field 48, an inlet buffer 50A, and an outlet buffer 50B.

The plurality of first fluid passage beads 53 are formed integrally with, and protrude from the surface 30a of the first metal separator toward the resin film equipped MEA 28, and are formed around the oxygen-containing gas supply passage 34a, the oxygen-containing gas discharge passage 34b, the coolant supply passage 36a, the coolant discharge passage 36b, the fuel gas supply passage 38a, and the fuel gas discharge passage 38b, respectively.

The fluid passage bead 53 has a polygonal shape formed by connecting a plurality of straight segments by bent segments in a plane view. For example, the fluid passage bead 53 has a quadrangular shape, a pentagonal shape, or a hexagonal shape. In the fluid passage bead 53, a segment which looks like a straight line as a whole is referred to as a straight segment herein in broad terms, and is not necessarily limited to have an exact straight line. For example, the straight segment includes a pattern which looks like a line extending straight in a predetermined direction as a whole even if it includes a wavy serpentine portion.

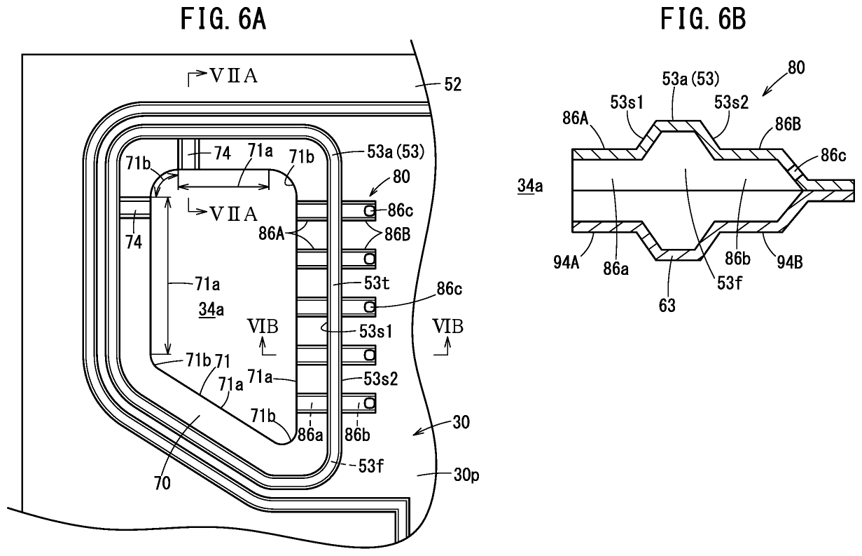

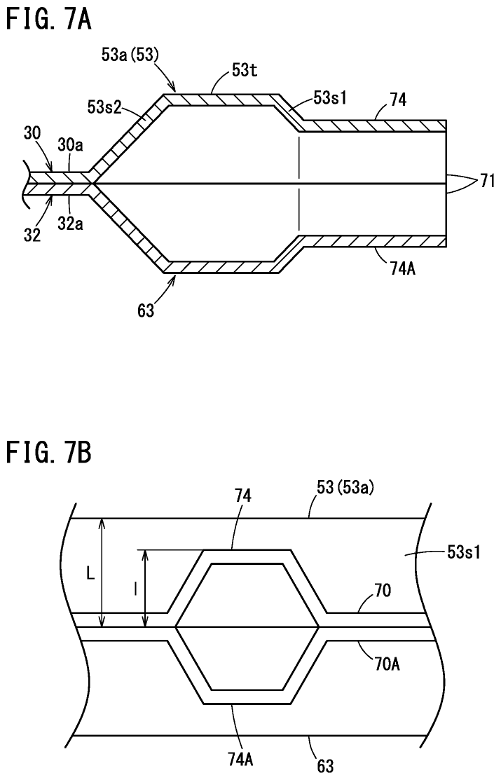

As shown in FIGS. 6A and 7A, the fluid passage bead 53 includes an inner peripheral side wall 53s1 and an outer peripheral side wall 53s2 rising upright from a base plate 30p of a main surface of the first metal separator 30, and a top portion 53t connecting the inner peripheral side wall 53s1 and the outer peripheral side wall 53s2. The inner peripheral side wall 53s1 and the outer peripheral side wall 53s2 of the fluid passage bead 53 are inclined from the separator thickness direction (direction normal to the base plate 30p). Therefore, the fluid passage bead 53 has a trapezoidal shape in cross section taken along the separator thickness direction.

It should be noted that the inner peripheral side wall 53s1 and the outer peripheral side wall 53s2 of the fluid passage bead 53 may be in parallel with the separator thickness direction. In this case, the fluid passage bead 53 has a rectangular shape in cross section taken along the separator thickness direction.

As shown in FIG. 5, a flange 70 is formed inside the fluid passage bead 53 (on the side adjacent to the fluid passage), along the same plane as the base plate 30p. The flange 70 extends from a root of the fluid passage bead 53 toward the oxygen-containing gas supply passage 34a, the oxygen-containing gas discharge passage 34b, the coolant supply passage 36a, the coolant discharge passage 36b, the fuel gas supply passage 38a, and the coolant discharge passage 38b. The inner marginal portion 71 of the flange 70 forms each edge of the fluid passages 34a, 34b, 36a, 36b, 38a, and 38b.

As shown in FIG. 6A, the inner marginal portion 71 of the flange 70 includes a plurality of straight segments 71a and curved segments 71b connecting the straight segments 71a oriented in different directions. In the illustrated example, the inner marginal portion 71 includes four straight segments 71a, and four curved segments 71b, and has a longitudinally elongated rectangular shape in a plan view. The shape of the inner marginal portion 71 is not limited to the rectangular shape. The inner marginal portion 71 may have a polygonal shape such as a pentagonal shape or a hexagonal shape.

Hereinafter, the oxygen-containing gas flow field 48 and fluid passage beads 53a, 53b in communication with the oxygen-containing gas flow field 48 will be described specifically. As shown in FIG. 5, the fluid passage beads 53a, 53b around the oxygen-containing gas supply passage 34a and the oxygen-containing gas discharge passage 34b are surrounded by the outer bead 52. Further, the fluid passage beads 53a, 53b are provided with bridge sections 80, 82 as areas where one or a plurality of connection channels connecting the inner side (fluid passages 34a, 34b) and the outer side (oxygen-containing gas flow field 48) are formed, and tunnels 74 as stress relief structure.

The bridge section 80 is provided in the annular fluid passage bead 53a around the oxygen-containing gas supply passage 34a. The bridge section 80 is provided at a position of a fluid passage bead 53a between the oxygen-containing gas flow field 48 and the oxygen-containing gas supply passage 34a.

The bridge section 82 is provided in the annular fluid passage bead 53b around the oxygen-containing gas discharge passage 34b. The bridge section 82 is provided at a position of the fluid passage bead 53b between the oxygen-containing gas flow field 48 and the oxygen-containing gas discharge passage 34b.

The fluid passage bead 53a and the fluid passage bead 53b have the same structure. Further, the bridge section 80 adjacent to the oxygen-containing gas supply passage 34a and the bridge section 82 adjacent to the oxygen-containing gas discharge passage 34b have the same structure.

As shown in FIG. 6B, a plurality of connection channels are provided in the bridge section 80. The connection channels include tunnels 86 protruding from the side wall of the fluid passage bead 53a. The tunnels 86a are formed by press forming, and formed by expansion in the separator thickness direction. The tunnels 86 of the connection channel include a plurality of inner tunnels 86A protruding from the inner peripheral side wall 53s1 of the fluid passage bead 53a toward the oxygen-containing gas supply passage 34a, and a plurality of outer tunnels 86B protruding from the outer peripheral side wall 53s2 of the fluid passage bead 53a toward the oxygen-containing gas flow field 48 (FIG. 5).

The plurality of inner tunnels 86A and the plurality of outer tunnels 86B protrude from the fluid passage bead 53a oppositely to each other in the separator surface direction (direction perpendicular to the stacking direction). As shown in FIG. 6A, the inner tunnel 86A and the plurality of outer tunnels 86B are disposed oppositely to each other through the fluid passage bead 53a. It should be noted that the inner tunnels 86A and the outer tunnels 86B may be disposed in a zigzag pattern along the direction in which the fluid passage bead 53a extends.

As shown in FIG. 6B, ends of the plurality of inner tunnels 86A opposite to the side connected to the fluid passage bead 53a are opened at the oxygen-containing gas supply passage 34a. The outer tunnels 86B are arranged at intervals in an extending direction in which the fluid passage bead 53a extends. An opening 86c is provided at an end of the outer tunnel 86B opposite to the side connected to the fluid passage bead 53a. The opening 86c penetrates through the inside and the outside of the outer tunnel 86B.

The inner space 53f of the fluid passage bead 53a is connected to the inner spaces 86a of the inner tunnels 86A, and connected to the inner spaces 86b of the outer tunnels 86B. Therefore, the oxygen-containing gas supply passage 34a is connected to the oxygen-containing gas flow field 48 (FIG. 5) through the inner tunnels 86A, the passage bead 53a, and the outer tunnels 86B of the bridge section 80.

The first metal separator 30 has a dual bead section where fluid passage bead 53a and the outer bead 52 are provided in parallel to each other. The flange 70 adjacent to the dual seal has tunnels 74 as stress relief structure.

As shown in FIG. 7A, in the same manner as the tunnels 86A (FIG. 6A) of the bridge section 80, the tunnels 74 are formed integrally with the first metal separator 30 by press forming to protrude by expansion in the separator thickness direction. The tunnel 74 extends from the inner peripheral side wall 53s1 of the fluid passage bead 53a, and is oriented toward the inner marginal portion 71 of the flange 70. The inner marginal portion of the tunnel 74 is opened to the inner marginal portion 71 of the flange 70.

As shown in FIG. 7B, the cross sectional surface of the tunnel 74 has a trapezoidal shape which is narrowed toward the front end. The side walls of the tunnel 74 are inclined from the separator thickness direction. The protruding distance (height I) in the separator thickness direction from the flange 70 of the tunnel 74 is smaller than the height L of the fluid passage bead 53a. Further, the bottom side length (width), the upper side length (width), and the height of the tunnel 74 can have the same values as the bottom side length (width), the upper side length (width), and the height of tunnel 86A (FIG. 6A) of the bridge section 80.

Further, a tunnel 74A is formed on the second metal separator 32, at a position facing the tunnel 74. The tunnel 74A is formed to protrude in a direction opposite to the tunnel 74. The cross sectional shape of the tunnel 74A is symmetrical with that of the tunnel 74 and formed by inverting the tunnel 74 upside down.

As shown in FIG. 6A, each of the tunnels 74 is provided in the straight segment 71a at a portion adjacent to the curved segment 71b of the inner marginal portion 71 of the flange 70. That is, the tunnel 74 is disposed in a portion of the inner marginal portion 71 close to the curved segment 71b in comparison with the center of the straight segment 71a of the inner marginal portion 71. The tunnel 74 is not connected to the straight segment 71a adjacent to the bridge section 80, in the inner marginal portion 71, and the tunnel 74 is provided adjacent to the curved segment 71b having a sharp curve in the portion adjacent to the double seal. It is because the curved segment 71b tends to have large stress, and tends to be bent in the thickness direction.

It should be noted that, in the case where the tunnel 74 is provided in the curved segment 71b of the flange 70, since the bending rigidity of the flange 70 is decreased, the tightening load application would raise concerns of significant deformation in the portion adjacent to the curved segment 71b. Therefore, it is preferable not to provide the tunnel 74 in the curved segment 71b but to provide the tunnel 74 in the straight segment 71a. Further, when the tunnel 74 is formed in the portion remote from the curved segment 71b, since the effect of suppressing stress concentration in the curved segment 71b under the tightening load application to the curved segment 71b is decreased, the tunnel 74 is preferably provided at a position close to the curved segment 71b.

The tunnel 74 may be provided in each of two straight segments 71a on both sides of the curved segment 71b. Further, the tunnel 74 may be provided only in one of the straight segments 71a adjacent to the curved segment 71b. It is not necessary to provide the tunnel 74 with respect to all of the curved segments 71b. It is preferable to provide the tunnel 74 at positions adjacent to only some of the curved segments 71b close to the outer circumference of the first metal separator 30 where the stress tends to be concentrated.

In the case where the bridge sections 80, 82 are provided in the fluid passage beads 53a, 53b, the tunnel 74 is formed in the straight segment 71a other than the straight segment 71a where the bridge section 80 is formed.

The fluid passage bead 53b may have the bridge section 82 and the tunnels 87 as in the case of the bridge section 80, and the tunnels 74 are also formed in the flange 70 inside the fluid passage bead 53b. Further, the flange 70 surrounding the fuel gas supply passage 38a, and the fuel gas discharge passage 38b of the first metal separator 30 is provided with tunnels 96A facing tunnels 96 formed in the second metal separator 32 described later.

It should be noted that, as in the case of the flanges 70 surrounding the coolant supply passage 36a and the coolant discharge passage 36b, the flange 70 in the portion which is not doubly sealed by the outer bead 52 and the fluid passage bead 53 may have the tunnels 74. That is, the flanges 70 in the portions of the fuel gas supply passage 38a and the fuel gas discharge passage 38b in FIG. 5 which are singly sealed may have the tunnel 74.

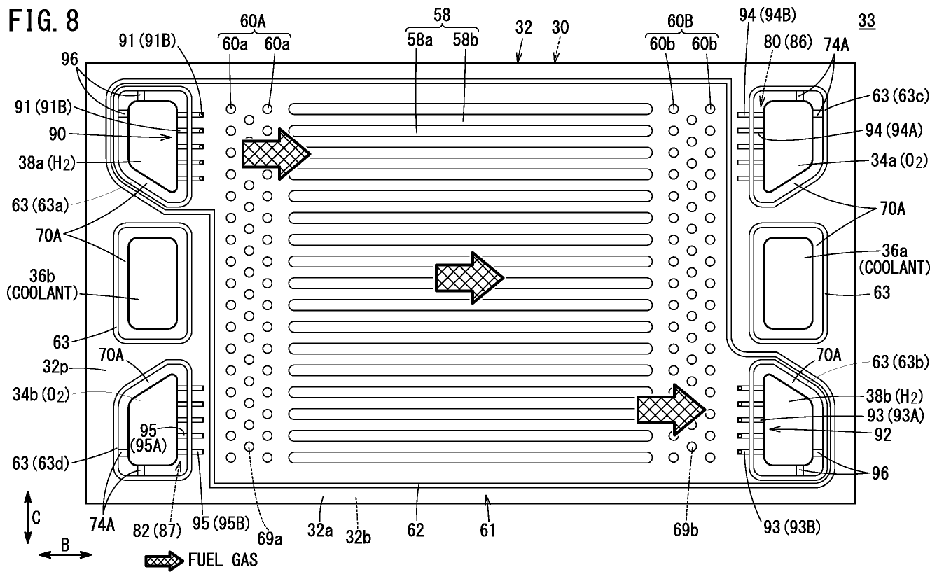

As shown in FIG. 8, the second metal separator 32 has a plurality of tunnels 74A, 91, 93, 94, 95, 96 protruding from the fluid passage bead 63 around the fluid passages 34a, 34b, 38a, 38b, in the separator surface direction, facing the plurality of tunnels 74, 86, 87, 88, 89, 96A provided in the first metal separator 30. These tunnels 74A, 91, 93, 94, 95, are formed integrally with the second metal separator 32 by press forming, formed by expansion toward the resin film equipped MEA 28 and opposed to the first metal separator 30 adjacent to the resin film equipped MEA 28. Further, as shown in FIGS. 7A and 7B, these tunnels 74A, 91, 93, 94, 95, 96 have a trapezoidal shape in cross section taken along the separator thickness direction.

As shown in FIG. 7B, the tunnel 74A of the second metal separator 32 is formed in a portion facing the tunnel 74 of the first metal separator 30 as described above. Further, the tunnel 94 is a tunnel provided to face the tunnel 86 of the bridge section 80 of the first metal separator 30. The tunnel 95 is a tunnel provided to face the tunnel 87 of the bridge section 82 of the first metal separator 30. These tunnels 94, 95 do not have through holes, and are not connected to a surface 32a of the second metal separator 32.

As shown in FIG. 4, for example, the second metal separator 32 has a fuel gas flow field 58 on its surface 32a facing the resin film equipped MEA 28 (hereinafter referred to as the surface 32a). For example, the fuel gas flow field 58 extends in the direction indicated by the arrow B. As shown in FIG. 8, the fuel gas flow field 58 is in fluid communication with the fuel gas supply passage 38a and the fuel gas discharge passage 38b. The fuel gas flow field 58 includes straight flow grooves 58b between a plurality of ridges 58a extending in the direction indicated by the arrow B. Instead of the plurality of straight flow grooves 58b, a plurality of wavy flow grooves may be provided.

An inlet buffer 60A is provided on the surface 32a of the second metal separator 32, between the fuel gas supply passage 38a and the fuel gas flow field 58. The second inlet buffer 60A comprises a plurality of boss arrays each comprising a plurality of bosses 60a arranged in the direction indicated by the arrow C. Further, an outlet buffer 60B is provided on the surface 32a of the second metal separator 32, between the fuel gas discharge passage 38b and the fuel gas flow field 58. The outlet buffer 60B comprises a plurality of boss arrays each comprising a plurality of bosses 60b.

It should be noted that, on a back surface 32b of the second metal separator 32 opposite to the fuel gas flow field 58, boss arrays each comprising a plurality of bosses 69a arranged in the direction indicated by the arrow C are provided between the boss arrays of the inlet buffer 60A, and boss arrays each comprising a plurality of bosses 69b arranged in the direction indicated by the arrow C are provided between the boss arrays of the outlet buffer 60B. The bosses 69a, 69b comprise a buffer on the coolant flow surface.

A second seal line 61 is formed on the surface 32a of the second metal separator 32 by press forming. The second seal line 61 is formed by expansion toward the resin film equipped MEA 28. The second seal line 61 includes an outer bead 62 and a plurality of fluid passage beads 63 (bead seals). The outer bead 62 protrudes from the surface 32a of the second metal separator 32 toward the resin film equipped MEA 28, and surrounds the fuel gas flow field 58, the inlet buffer 60A, the outlet buffer 60B, and the fluid passage bead 63 around the fuel gas supply passage 38a, and the fuel gas discharge passage 38b.

As shown in FIG. 3, the resin member 56b is fixed to the protruding top surface of the second seal line 61 by printing or coating. For example, polyester fiber is used as the resin member 56b. The resin member 56b may be provided on the part of the resin film 46. The resin member 56b is not essential. The resin member 56b may be dispensed with.

As shown in FIG. 8, the plurality of fluid passage beads 63 protrude integrally with, and protrude from the base plate 32p of the surface 32a of the second metal separator 32, and surround the oxygen-containing gas supply passage 34a, the oxygen-containing gas discharge passage 34b, the fuel gas supply passage 38a, the fuel gas discharge passage 38b, the coolant supply passage 36a, and the coolant discharge passage 36b, respectively. A flat flange 70A is formed inside each of the fluid passage beads 63. The flange 70A extends along the surface 32a. Fluid passage beads 63a, 63b have the same structure as the fluid passage beads 53a, 53b (FIG. 5) provided for the first metal separator 30.

Further, the second metal separator 32 is provided with bridge sections 90, 92 as areas where one or a plurality of connection channels connecting the inner side of the fluid passage beads 63a, 63b surrounding the fuel gas supply passage 38a and the fuel gas discharge passage 38b, respectively (on the side adjacent to the fluid passages 38a, 38b) and the outer side (on the side adjacent to the fuel gas flow field 58), and tunnels 96.

The fluid passage bead 63a having a shape (annular shape) surrounding the fuel gas supply passage 38a includes the bridge section 90 at a position between the fuel gas flow field 58 and the fuel gas supply passage 38a,. The fluid passage bead 63b having a shape (annular shape) surrounding the fuel gas discharge passage 38b includes the bridge section 92 at a position between the fuel gas flow field 58 and the fuel gas discharge passage 38b.

The bridge sections 90, 92 provided in the second metal separator 32 have the same structure as the above described bridge sections 80, 82 (FIG. 5) provided in the first metal separator 30. Each of the bridge sections 90, 92 has a plurality of tunnels 91, 93.

Further, the flange 70A of the second metal separator 32 is provided with tunnels 96 as stress relief structure. The tunnels 96 have the same structure as the tunnels 74 provided in the flange 70 of the first metal separator 30.

As shown in FIG. 5, the first metal separator 30 is provided with a plurality of tunnels 88, 89, facing the plurality of tunnels 91, 93 (bridge sections 90, 92) (FIG. 8) provided in the second metal separator 32. The plurality of tunnels 88, 89 have the same structure as the plurality of tunnels 94, 95 (FIG. 8).

Further, the first metal separator 30 has a plurality of tunnels 96A facing a plurality of tunnels 96 provided in the flange 70A of the second metal separator 32 and protruding in a direction opposite to the second metal separator. The plurality of tunnels 96A have the same structure as the plurality of tunnels 96 described above.

As shown in FIGS. 3 and 4, a coolant flow field 66 is formed between the back surface 30b of the first metal separator 30 and the back surface 32b of the second metal separator 32 that are joined together. The coolant flow field 66 is connected to the coolant supply passage 36a and the coolant discharge passage 36b. When the first metal separator 30 and the second metal separator 32 are stacked together, the coolant flow field 66 is formed between the back surface of the oxygen-containing gas flow field 48 of the first metal separator 30 and the back surface of the fuel gas flow field 58 of the second metal separator 32. The first metal separator 30 and the second metal separator 32 are joined together by welding outer circumferential portions of the first metal separator 30 and the second metal separator 32 and the fluid passages 34a, 34b, 36a, 36b, 38a, 38b together. The first metal separator 30 and the second metal separator 32 may be joined together by brazing instead of welding.

As shown in FIG. 2, the terminal plates 16a, 16b are made of electrically conductive material, e.g., made of metal such as copper, aluminum, or stainless steel. Terminal units 68a, 68b are provided at substantially the centers of the terminal plates 16a, 16b, respectively. The terminal units 68a, 68b extend outward in the stacking direction.

Each of the insulators 18a, 18b is made of insulating material such as polycarbonate (PC) or phenol resin. Recesses 76a, 76b are formed at the centers of the insulators 18a, 18b, respectively. The recesses 76a, 76b are opened toward the stack body 14. Holes 72a, 72b are provided at the bottoms of the recesses 76a, 76b, respectively.

At one end of the insulator 18a and the end plate 20a in the direction indicated by the arrow B, the oxygen-containing gas supply passage 34a, the coolant supply passage 36a and the fuel gas discharge passage 38b are provided. At the other end of the insulator 18a and the end plate 20a in the direction indicated by the arrow B, the fuel gas supply passage 38a, the coolant discharge passage 36b, and the oxygen-containing gas discharge passage 34b are provided.

As shown in FIGS. 2 and 3, the terminal plate 16a is placed in the recess 76a of the insulator 18a, and the terminal plate 16b is placed in the recess 76b of the insulator 18b.

As shown in FIG. 1, coupling bars 24 are disposed between the sides of the end plates 20a, 20b. Both ends of the coupling bars 24 are fixed to the inner surfaces of the end plates 20a, 20b using bolts 26, and a tightening load in the stacking direction is applied to the stack body 14 to assemble the fuel cell stack 10.

Hereinafter, operation of the fuel cell stack 10 having the above structure will be described.

Firstly, as shown in FIG. 1, an oxygen-containing gas such as the air is supplied to the oxygen-containing gas supply passage 34a of the end plate 20a. A fuel gas such as a hydrogen-containing gas is supplied to the fuel gas supply passage 38a of the end plate 20a. A coolant such as pure water, ethylene glycol, or oil is supplied to the coolant supply passage 36a of the end plate 20a.

As shown in FIG. 4, the oxygen-containing gas flows from the oxygen-containing supply passage 34a into the oxygen-containing gas flow field 48 of the first metal separator 30 through the bridge section 80 (see FIG. 5). At this time, as shown in FIG. 7A, the oxygen-containing gas temporarily flows from the oxygen-containing gas supply passage 34a to the back surface 30b of the first metal separator 30 (between the first metal separator 30 and the second metal separator 32), flows through the bridge section 80, and flows from the openings 86c to the surface 30a of the first metal separator 30. Then, as shown in FIG. 4, the oxygen-containing gas flows along the oxygen-containing gas flow field 48 in the direction indicated by the arrow B, and the oxygen-containing gas is supplied to the cathode 44 of the membrane electrode assembly 28a.

In the meanwhile, the fuel gas flows from the fuel gas supply passage 38a into the fuel gas flow field 58 of the second metal separator 32 through the bridge section 90 (see FIG. 8). The fuel gas moves along the fuel gas flow field 58 in the direction indicated by the arrow B, and the fuel gas is supplied to the anode 42 of the membrane electrode assembly 28a.

Thus, in each of the membrane electrode assemblies 28a, the oxygen-containing gas supplied to the cathode 44 and the fuel gas supplied to the anode 42 are consumed in the electrochemical reactions in a second electrode catalyst layer 44a and a first electrode catalyst layer 42a to perform power generation.

Then, the oxygen-containing gas supplied to the cathode 44 is consumed at the cathode 44, and the remainder of the oxygen-containing gas flows from the oxygen-containing gas flow field 48 into the oxygen-containing gas discharge passage 34b through the bridge section 82, and then, the oxygen-containing gas is discharged along the oxygen-containing gas discharge passage 34b in the direction indicated by the arrow A. Likewise, the fuel gas supplied to the anode 42 is consumed at the anode 42, and the remainder of the fuel gas flows from the fuel gas flow field 58 into the fuel gas discharge passage 38b through the bridge section 92, and then, the fuel gas is discharged along the fuel gas discharge passage 38b in the direction indicated by the arrow A.

Further, the coolant supplied to the coolant supply passage 36a flows into the coolant flow field 66 formed between the first metal separator 30 and the second metal separator 32, and then, the coolant flows along the coolant flow field 66 in the direction indicated by the arrow B. After the coolant cools the membrane electrode assembly 28a, the coolant is discharged from the coolant discharge passage 36b.

The power generation cell 12 (fuel cell stack 10) having the first metal separator 30 and the second metal separator 32 according to the embodiment of the present invention offers the following advantages.

The fuel cell metal separator (the first metal separator 30 and the second metal separator 32) according to the embodiment of the present invention relates to a fuel cell metal separator including the reactant gas flow field (the oxygen-containing gas flow field 48 and the fuel gas flow field 58) configured to allow an oxygen-containing gas or a fuel gas to flow in the direction along the electrode surface, the fluid passage (fluid passages 34a, 34b, 38a, 38b) connected to the reactant gas flow field and penetrating through the fuel cell metal separator in the separator thickness direction, the metal bead seal (fluid passage beads 53, 63) provided around outer circumference of the fluid passage, and protruding in the separator thickness direction, the flange 70, 70A provided between the root of the bead seal and the fluid passage, and the bridge section 80, 82, 90, 92 protruding from the side wall of the bead seal and protruding from the separator main surface in the separator thickness direction. The connection channel configured to connect the fluid passage and the reactant gas flow field is formed in the bridge section. The metal separator is stacked on the membrane electrode assembly 28a in the stacking direction, and a compression load is applied to the metal separator in the stacking direction.

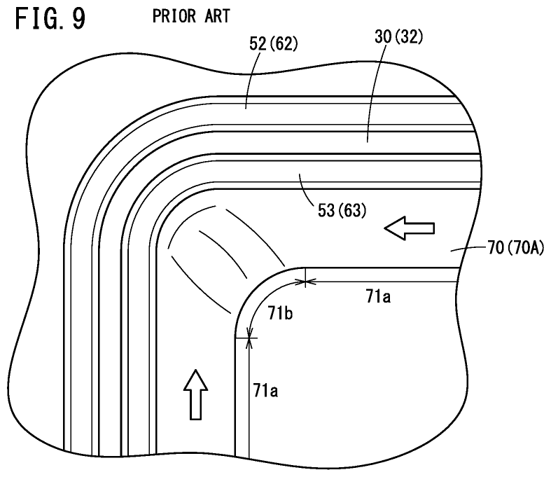

In the case where the fuel cell metal separator as described above is incorporated into the power generation cell 12, and the tightening load is applied to the fuel cell metal separator in the stacking direction, stress is applied to the surfaces of the flanges 70, 70A so as to stretch the flanges 70, 70A toward the fluid passages, and the compression stress along the surfaces of the flange 70, 70A is concentrated on the curved segment 71b. Therefore, as shown in FIG. 9, in a fuel cell metal separator according to a comparative example where no tunnels 74, 74A, 96, 96A is provided in the flange 70, 70A, the portion of the flange 70, 70A adjacent to the curved segment 71b bends.

In contrast, in the fuel cell metal separator according to the embodiment of the present invention, in the flange 70, 70A, the inner marginal portion 71 is formed to have an annular shape by connecting the plurality of straight segments 71a and the curved segments 71b which connects the straight segments 71a. In the inner marginal portion 71, the tunnel 74, 74A, 96, 96A is provided in the straight segment 71a adjacent to the curved segment 71b in a section other than the bridge section 80, 82, 90, 92. The tunnel 74, 74A, 96, 96A is connected to the bead seal, and is formed by expansion in the separator thickness direction.

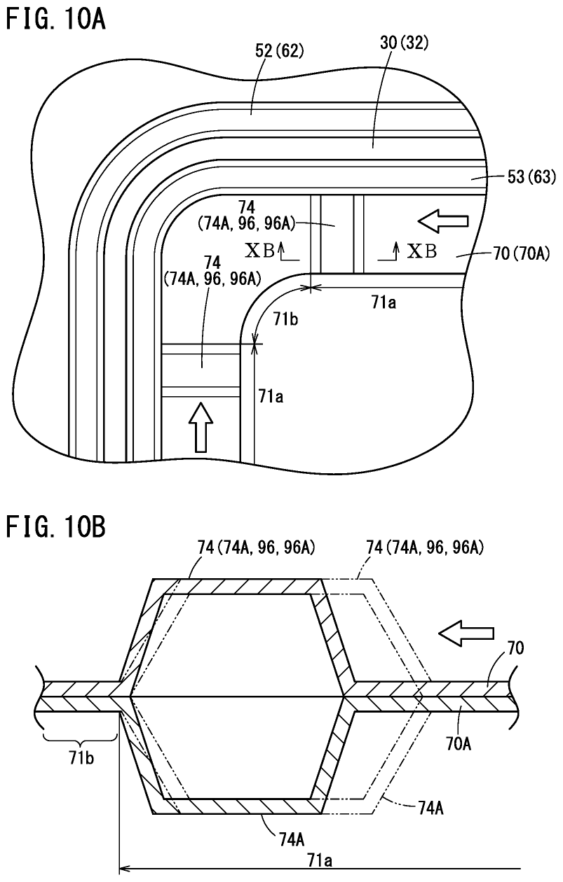

In the above fuel cell metal separator, as shown in FIGS. 10A and 10B, the compression stress in the direction along the surface of the flange 70, 70A is relieved by elastic deformation of the side walls of the tunnels 74, 74A, 96, 96A. In the structure, it is possible to prevent bending of the curved segment 71b, and apply the uniform pressure to the bead seal around the fluid passage. Therefore, it is possible to maintain the desired sealing performance.

In the above fuel cell metal separator, the tunnels 74, 74A, 96, 96A may be formed in a portion of the flange 70, 70A surrounding the fluid passage, adjacent to the curved segment 71b close to outer circumference of the fuel cell metal separator. In the structure, since the tunnels 74, 74A, 96, 96A as the stress relief structure are formed adjacent to the curved segment 71b where the stress is likely to be concentrated, it is possible to more effectively prevent bending of the curved segment 71b. Further, since the tunnels 74, 74A, 96, 96A are provided at the position where the curved segment 71b is not provided, it is possible to prevent decrease in the rigidity of the flanges 70, 70A, and prevent deformation of the curved segment 71b.

In the above fuel cell metal separator, the second bead seal (outer bead 52) around the reactant gas flow field and the bead seal (fluid passage bead 53, 63) may be provided, and the tunnel 74, 74A, 96, 96A may be provided in the flange 70, 70A doubly surrounded by the bead seal and the second bead seal.

In the above fuel cell metal separator, the bridge section 80, 82, 90, 92 may include a plurality of connection channels (the tunnels 86, 86A) protruding from the side wall of the bead seal, and the connection channels and the tunnels 74, 74A, 96, 96A may have the same height in the separator thickness direction.

In the above fuel cell metal separator, the tunnel 74, 74A, 96, 96A may have a trapezoidal shape in cross section. In the structure, it becomes possible to easily deform the tunnel 74, 74A, 96, 96A, and reliably relieve the stress in the surface direction of the flange 70, 70A.

The power generation cell 12 according to the embodiment of the present invention includes the fuel cell metal separator and the membrane electrode assembly 28a stacked on the fuel cell metal separator. In the structure, since it is possible to prevent deformation of the flange 70, 70A, it is possible to achieve the power generation cell 12 having a higher degree of reliability.

### Modified Embodiment

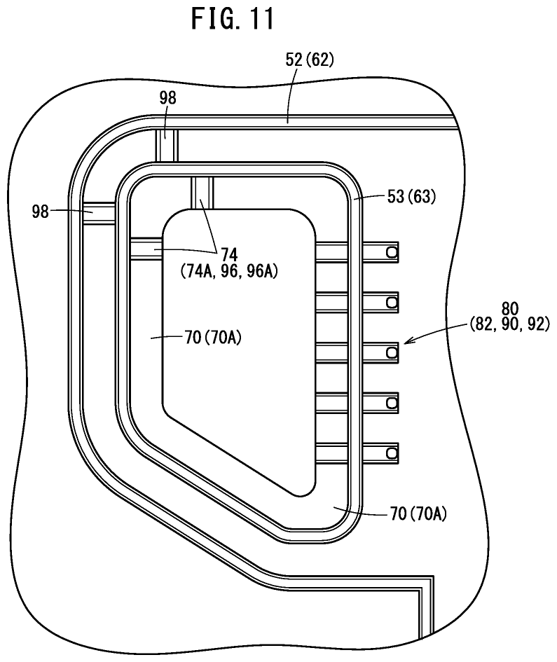

In the first metal separator 30 and the second metal separator 32 (fuel cell metal separator) described above, as shown in FIG. 11, tunnels 98 may protrude on the opposite side (outside) of the tunnels 74, 74A, 96, 96A with the fluid passage beads 53, 63 (bead seals) intervening there between. In this structure, since it is possible to achieve the uniform rigidity of the bead seal adjacent to the tunnels 74, 74A, 96, 96A, it is possible to maintain the desired seal performance of the bead seal.

As described above, in the case where the tunnel 98 is provided outside the fluid passage beads 53, 63 (bead seal), the tunnels 74, 74A, 96, 96A inside the fluid passage bead 53, 63 and the tunnels 98 outside the fluid passage bead 53, 63 may be offset from each other in the extending direction in which the fluid passage bead 53, 63 extends. In the structure, since variation in the rigidity of the bead seal is suppressed, and variation in the tightening load applied to the fluid passage beads 53, 63 is suppressed, it is possible to maintain the desired sealing performance of the fluid passage beads 53, 63.

Although the present invention has been described with reference to the preferred embodiments, the present invention is not limited to the above embodiments. It is a matter of course that various modifications may be made without departing from the gist of the present invention.

What is claimed is:

1. A fuel cell metal separator comprising:
a reactant gas flow field configured to allow an oxygen-containing gas or a fuel gas to flow in a direction along an electrode surface;
a fluid passage connected to the reactant gas flow field and penetrating through the fuel cell metal separator in a separator thickness direction;
a metal bead seal provided around the fluid passage, and protruding in the separator thickness direction;
a flange provided between a root of the bead seal and the fluid passage; and
a bridge section protruding from a side wall of the bead seal and protruding from a separator main surface in the separator thickness direction, a connection channel configured to connect the fluid passage and the reactant gas flow field being formed in the bridge section,
the fuel cell metal separator being stacked on a membrane electrode assembly in a stacking direction, and a compression load being applied to the metal separator in the stacking direction,
wherein an inner marginal portion of the flange is formed to have an annular shape by connecting a plurality of straight segments and curved segments, each of which connects the straight segments; and
a tunnel connected to the bead seal, and formed by expansion of the flange in the separator thickness direction is provided in the straight segment of the flange adjacent to the curved segment in a section other than the bridge section.

2. The fuel cell metal separator according to claim 1, wherein the tunnel is formed in a portion of the flange surrounding the fluid passage, adjacent to at least one of the curved segments close to an outer circumference of the fuel cell metal separator.

3. The fuel cell metal separator according to claim 1, further comprising, in addition to the tunnel, a tunnel protruding on a side opposite to the tunnel across the bead seal.

4. The fuel cell metal separator according to claim 3, wherein the tunnel inside the bead seal and the tunnel outside the bead seal are offset from each other in an extending direction in which the bead seal extends.

5. The fuel cell metal separator according to claim 1, further comprising a second bead seal around the reactant gas flow field and the bead seal, and the tunnel is provided in the flange doubly surrounded by the bead seal and the second bead seal.

6. The fuel cell metal separator according to claim 1, wherein the bridge section includes a plurality of connection channels protruding from the side wall of the bead seal, and the connection channels and the tunnel have the same height in the separator thickness direction.

7. The fuel cell metal separator according to claim 1, wherein tunnel has a trapezoidal shape in cross section.

8. A power generation cell comprising the fuel cell metal separator according to claim 1 and a membrane electrode assembly stacked on the fuel cell metal separator.
